(19) United States
(12) Patent Application Publication
(10) Pub. No.: US 2018/0015632 A1
(43) Pub. Date: Jan. 18, 2018

(54) CHAIN SAW

(71) Applicant: HUSQVARNA AB

(72) Inventor: Jörgen Johansson, Jönköping (SE)

(21) Appl. No.: 15/531,604

(22) PCT Filed: Dec. 15, 2014
(86) PCT No.: PCT/EP2014/077728

§ 371 Date: May 30, 2017

(51) Int. Cl. B27B 17/04; B27B 17/12

(52) U.S. Cl. CPC B27B 17/04; B27B 17/12

(57) ABSTRACT

The invention relates to a chain saw comprising a guide bar (1) for guiding a saw chain, wherein the guide bar (1) comprises two side plates (2, 3) between which a sprocket wheel (4) is rotatable arranged, wherein the sprocket wheel (4) is supported in the guide bar (1) by means of a bearing (5) and wherein the bearing (5) is supplied by a lubricant by means of a lubrication system (6). To improve the lubrication of the bearing the invention proposes that the lubrication system (6) comprises a lubrication reservoir (7) which is in fluidic connection (8) with the bearing (5), wherein the lubrication reservoir (7) is sealed against the environment by at least one valve element (9).

The invention relates to a chain saw comprising a guide bar for guiding a saw chain, wherein the guide bar comprises two side plates between which a sprocket wheel is rotatable arranged, wherein the sprocket wheel is supported in the guide bar by means of a bearing and wherein the bearing is supplied by a lubricant by means of a lubrication system.

A chain saw of the generic kind is disclosed in U.S. Pat. No. 4,361,960 A. Similar and other solutions are shown in U.S. Pat. No. 3,279,508 A, in U.S. Pat. No. 4,071,953 A, in U.S. Pat. No. 3,878,607 A, in U.S. Pat. No. 5,092,044 A, in U.S. Pat. No. 4,981,129 A and in SE 438 812 B.

It is known to use a hole in the side laminate (side plate) of the guiding bar of the chain saw which goes straight into the bearing. When a nose wheel bearing is lubricated, grease is pressed through this hole into the bearing and specifically in the engagement zone of the rollers of the same. The bearing is a sensitive part of the chain saw which suffers when contamination enters, especially dirt and dust. Pre-known concepts have no effective protection against that since the grease hole exposes the rollers of the bearing.

Another problem of efficient lubrication occurs when a shim seal is used in a nose bearing of a guide bar (in general, shim seals are mostly not sealing absolutely; also other types of seal can be employed, e.g. rubber seals, which have other sealing properties). Here, it is difficult to get lubrication into the bearing at all. Mostly, it is necessary to use a lubricant with low viscosity.

Thus, it is an object of the present invention to propose a chain saw of the kind mentioned above which allows a more efficient lubrication of the bearing which is necessary to support the sprocket wheel. Thus, it is aimed to improve the lubrication of the bearing, wherein a simple and thus cost-effective design is aimed for.

The solution of this object according to the invention is characterized in that the lubrication system comprises a lubrication reservoir which is in fluidic connection with the bearing, wherein the lubrication reservoir is sealed against the environment by at least one valve element.

Preferably, a shim is arranged between at least one of the side plates and the bearing, wherein the shim comprises the valve element. In this case the shim consists preferably of a sheet metal. The valve element can be established in the shim by an incision machined into the shim. The incision has preferably an arcuated shape, especially a semi-circular shape. The incision is preferably machines by a punching process. Also, laser cutting or water-cutting process has been proven as being beneficial.

The bearing is preferably a roller bearing; in general it is also possible that a sliding bearing is used instead of a roller bearing. It has an inner bearing ring which serves preferably as a hub for supporting the sprocket wheel. The lubrication reservoir is preferably established by a recess in the inner bearing ring. The recess in the inner bearing ring is preferably a centre bore in the inner bearing ring.

The fluidic connection is preferably established by at least one groove which is machined in the inner bearing ring. Preferably, a plurality of grooves is machined in the inner bearing ring. Alternatively to machining the grooves they could as well be introduced into the inner bearing ring by any other suitable method such as for example stamping. The grooves are preferably distributed equidistantly around the circumference of the inner bearing ring.

The at least one groove extends preferably radially in the inner bearing ring.

The side plates, the at least one shim and the inner bearing ring are preferably connected with another by means of screws or rivets.

Preferably, at least one of the side plates has a lubrication bore which is arranged above the valve element. By this lubrication bore a lubricant can be pressed respectively injected via the valve element in the shim into the reservoir.

Thus, the lubrication hole allows an easy re-lubrication of the system and the bearing, namely the central nose bearing of the guide bar. So, the proposed central lubrication system allows an efficient (re-) lubrication of the nose bearing in the guide bar.

Beneficially, the lubrication system is well protected against the environment, i. e. against dirt from the outside.

The fluidic connection is established by oil or grease channels which are in communication with the oil or grease reservoir. The reed valve which is integrated in the shim makes sure that no lubricant escapes from the reservoir.

The reed valve is a tongue shaped cut in the shim and functions as a one-way valve. When a lubricant (oil/grease) is pressed via the lubrication bore from the outside into the reservoir, the tongue bends and lets the lubricant into the reservoir; from there it is further guided to the bearing via the channels in the inner bearing ring.

With respect to the reservoir the following function is given: Then the bearing experiences poor lubrication conditions, the temperature will rise in the bearing and the adjacent parts and also in the reservoir which is filled with a lubricant. Thus, the pressure in the reservoir increases and the reed valve closes to avoid escape of lubricant from the reservoir. Thus, the lubricant is pressed vie the channels (fluidic connection) into the bearing region.

When the hub (bearing inner ring) is manufactured, an extra hole is preferably punched in the centre of the hub and oil/grease channels are stamped. This is made preferably in the fine punching process. The tongue (valve element) is machines in the centre of the shim. When grease is pressed form the outside into the bar, the tongue in the shim bends and lets lubricant into the centre hole of the hub and further into the channels. Via the channels lubricant then reaches the rollers of the bearing; thus, the bearing is well lubricated.

That is, the centre hole and the hub thus work as the lubricant reservoir. As mentioned, when the bearing experiences poor lubrication conditions the temperature rises. The grease which is filled in the centre hole expands and presses the tongue in the shim against the side laminates (side plates) and therewith closing the inlet gate. The expanding grease can only get out through the channels and will be pressed onto the rollers of the bearing; so, well lubrication conditions are restored in the bearing. Thus, the bearing is lubricated in this case automatically.

The proposed concept allows the lubrication of the sealed bearing with any kind of grease (also with a quite high viscosity). The lubrication hole for the lubrication from the outside of the guide bar is closed and prevents effectively the entry of dirt and debris which would contaminate the bearing.

Beneficially, the design of the proposed solution is quite simple and demands only parts which can be manufactured in an easy and thus cost-efficient manner. So, the realization of the proposed concept does not cause high costs.

In the drawings an embodiment of the invention is depicted.

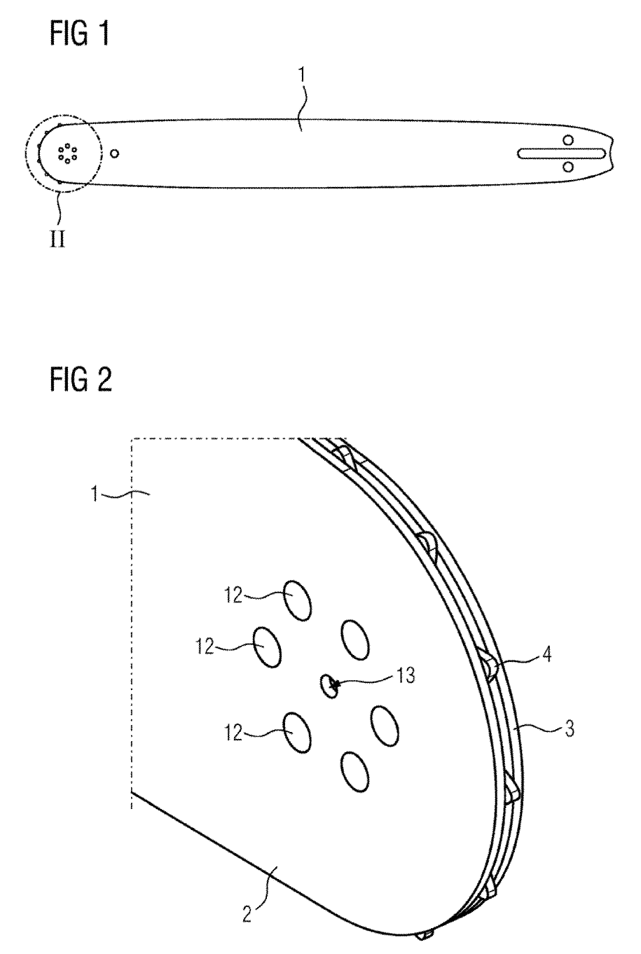

FIG. 1 shows a side view of a guide bar of a chain saw,

FIG. 2 shows a perspective view onto the axial end of the guide bar (see marking “II” in FIG. 1, which is enlarged in FIG. 2),

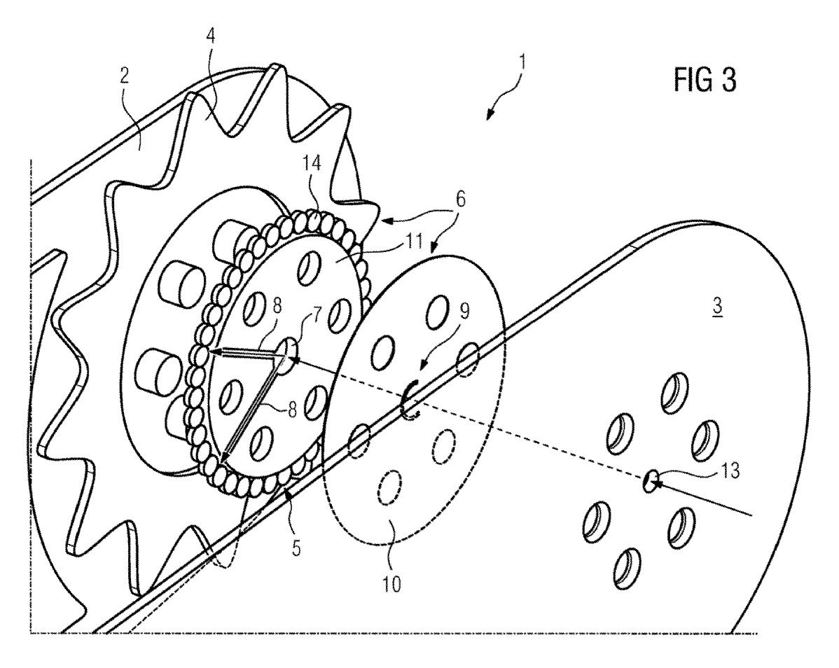

FIG. 3 shows an explosion view of the axial end of the guide bar according to FIG. 1,

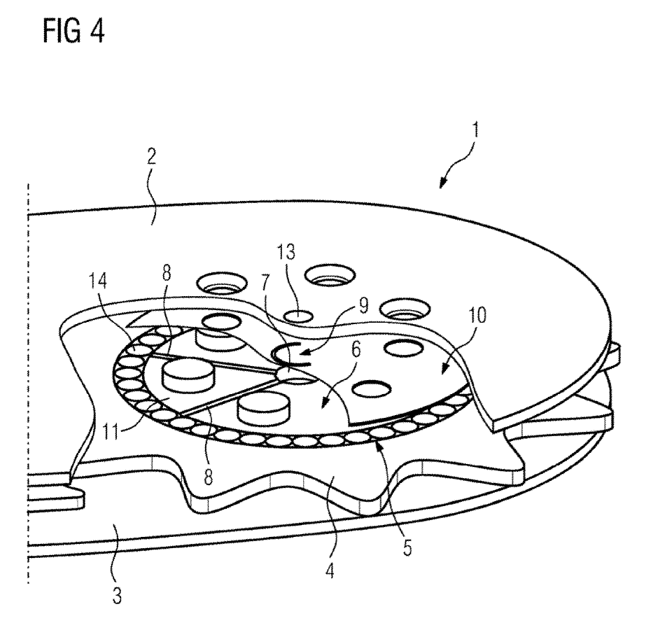

FIG. 4 shows a perspective view—partially broken—of the axial end of the guide bar in the mounted state and

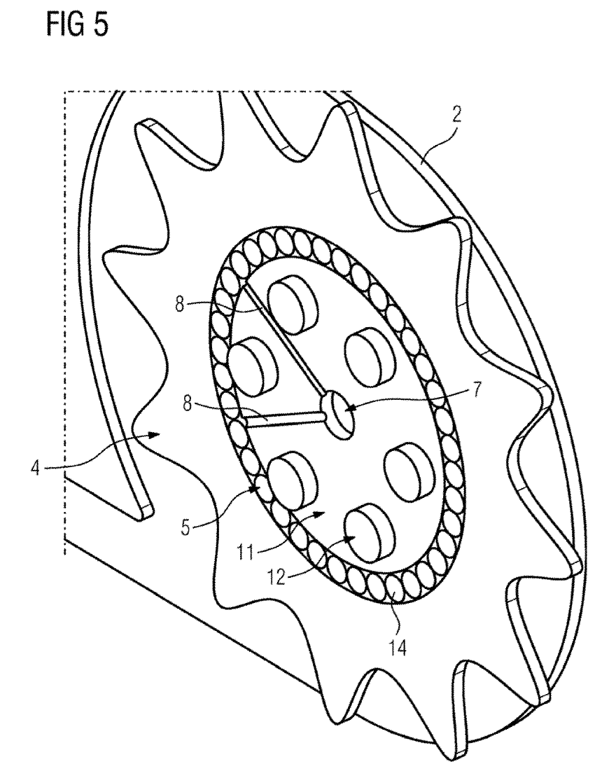

FIG. 5 shows a perspective view of the axial end of the guide bar with one of the side bars demounted.

In FIG. 1 a guide bar 1 of a chain saw is shown. The axial end of the guide bar 1 is shown in an enlarged depiction in FIG. 2. As can be seen here the guide bar 1 has two side plates 2 and 3 which are kept on a certain distance from another. Between the side plates 2, 3 a sprocket wheel 4 is supported by a (not visible) bearing. The whole arrangement is fixed by a number of rivets 12.

The general design of such a guide bar is detailed explained in the above mentioned documents. Insofar, explicitly reference is made to those documents.

The details of the design according to the present invention become apparent from FIGS. 3, 4 and 5 where the guide bar 1 and more specifically its axial end is shown in perspective view.

Here, the bearing 5 can be seen which is a roller bearing in the present case with a plurality of rolling element 14. The rolling elements 14 are arranged around an inner bearing ring 11 which is functioning as a hub for the sprocket wheel 4.

To ensure proper lubrication conditions during use of the chain saw a lubrication system 6 is employed. By this the bearing 5 is provided with a lubricant which can be oil or grease.

More specifically, the lubrication system 6 consists of a lubrication reservoir 7 which is formed by a central bore in the inner bearing ring 11. From the reservoir 7 a plurality of grooves 8 forming fluidic connections extend radially into the region of the rolling elements 14.

Furthermore, it is essential that the lubrication reservoir 7 is sealed against the environment by a valve element 9. The valve element 9 is formed in a shim 10 which is a thin disc which is mounted between one of the side plates 2 and/or 3 and the inner bearing ring 11. The sealing function of the valve element 9 is established by a semi-circular cut in the sheet metal material of which the shim 10 consists. The shim 10 can be produced by an etching process.

The function of the valve element 9 is described above.

To sum up, the proposed concept provides a chain saw which includes two side plates forming the guide bar, a shim, a hub (bearing inner ring), a nose sprocket and a plurality of rollers. A tongue (reed valve) is cut at the centre of the shim 10.

A hole 13 (lubrication bore) is provided on a side plate for the flow of a lubricant. The hub 11 is provided with some channels 8 for guiding the lubricant from the central hole towards the rolling elements 14 around the hub 11.

The flow of lubricant from the hole 13 via the fluidic connections 8 to the bearing 5 is shown in FIG. 3 by arrows.

The central hole in the hub works as a lubricant reservoir. The hole for lubrication (lubrication bore) 13 is located outside of the side plate which is closed. This prevents enter of dirt and debris to the rollers.

The (re-)lubrication can take place by injecting a lubricant via the lubrication bore 13 in one of the side plates 2, 3 as shown in FIGS. 2, 3 and 4.

It is sufficient that only one shim 10 is provided with the valve element 9. But it is also possible that both shims 10 at both sides of the inner bearing ring 11 are respectively equipped with a valve.

### LIST OF REFERENCE NUMERALS

1 Guide bar
2 Side plate
3 Side plate
4 Sprocket wheel
5 Bearing
6 Lubrication system
7 Lubrication reservoir
8 Fluidic connection/Groove
9 Valve element
10 Shim
11 Inner bearing ring/Hub
12 Screw/Rivet
13 Lubrication bore
14 Rolling element

1. Chain saw comprising a guide bar for guiding a saw chain, wherein the guide bar comprises two side plates between which a sprocket wheel is rotatably arranged, wherein the sprocket wheel is supported in the guide bar by a bearing and wherein the bearing is supplied with lubricant by a lubrication system,
wherein the lubrication system comprises a lubrication reservoir which is in fluidic connection with the bearing, wherein the lubrication reservoir is sealed against the environment by a valve element.

2. The chain saw according to claim 1, characterized in that a shim is arranged between at least one of the side plates and the bearing, wherein the shim comprises the valve element.

3. The chain saw according to claim 2, characterized in that the shim consists of a sheet metal.

4. The chain saw according to claim 2, characterized in that the valve element is established in the shim by an incision machined into the shim.

5. The chain saw according to claim 4, characterized in that the incision has an arcuated shape, especially a semi-circular shape.

6. The chain saw according to claim 1, characterized in that the bearing is a roller bearing.

7. The chain saw according to claim 1, characterized in that the bearing has an inner bearing ring which serves as a hub for supporting the sprocket wheel.

8. The chain saw according to claim 7, characterized in that the lubrication reservoir is established by a recess in the inner bearing ring.

9. The chain according to claim 8, characterized in that the recess in the inner bearing ring is a centre bore in the inner bearing ring.

10. The chain saw according to claim 7, characterized in that the fluidic connection is established by at least one groove which is machined in the inner bearing ring.

11. The chain saw according to claim 10, characterized in that a plurality of grooves is machined in the inner bearing ring.

12. The chain saw according to claim 11, characterized in that the grooves are distributed equidistantly around the circumference of the inner bearing ring.

13. The chain saw according to claim 10, characterized in that the at least one groove extends radially in the inner bearing ring.

14. The chain saw according to claim 1, characterized in that the side plates, the shim and the inner bearing ring are connected with another by screws or rivets.

15. The chain saw according to claim 1, characterized in that at least one of the side plates has a lubrication bore which is arranged above the valve element.
